(19) United States
(12) Patent Application Publication
(10) Pub. No.: US 2011/0136731 A1
(43) Pub. Date: Jun. 9, 2011

(54) PROTEIN HAVING PESTICIDAL ACTIVITY, DNA ENCODING THE PROTEIN, AND NOXIOUS ORGANISM-CONTROLLING AGENT THAT CONTROLS THE INSECT PEST, EMERALD ASH BORER (EAB), AGRILUS PLANIPENNIS

(76) Inventors: Leonora S. Bauer, Okemos, MI (US); John L. Libs, Oakland, CA (US)

(21) Appl. No.: 12/747,861

(22) PCT Filed: Dec. 10, 2008
(86) PCT No.: PCT/US08/86288

§ 371 Date: Feb. 16, 2011

Related U.S. Application Data
(60) Provisional application No. 61/007,297, filed on Dec. 11, 2007.

(51) Int. Cl. A01N 37/18; A01P 7/04

(52) U.S. Cl. 514/4.5

(57) ABSTRACT

A noxious organism-controlling agent disclosed herein is effective to pests that have acquired a resistance to conventional Bacillus thuringiensis (Bt) agents and has activity on Coleoptera pests and specifically against the emerald ash borer (EAB), Agrilus planipennis Fairmaire (Coleoptera: Buprestidae). Also disclosed is a microbe Bacillus thuringiensis serovar galleriae SDS502 strain having an ability of producing a toxic protein (Cry8Da) that can serve as an active ingredient of a noxious organism-controlling agent to control EAB.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of 07-RD-11242300-041 awarded by United States the Department of Agriculture Forest Service Northern Research Station.

### BACKGROUND

1. Field

The present application relates generally to compositions and methods for controlling noxious organisms and, more specifically, to compositions and methods for controlling the emerald ash borer (“EAB”), Agrilus planipennis.

2. Related Art

Bacillus thuringiensis (“Bt”) is a spore-forming, rod-shaped, gram-positive bacterium closely related to Bacillus cereus. A large number of Bt isolates have been found and grouped into subspecies, such as B. thuringiensis thuringiensis, B. thuringiensis kurstaki, B. thuringiensis aizawai, etc., based on a classification scheme originally developed by Bonnefoi and de Barjac in 1963. Bt is clearly distinguished from other bacilli by the production of intracellular crystals, which are insoluble deposits of proteins many of which have insecticidal activity against various insect species. During the sporulation process, Bt synthesizes large amounts of one or more of these proteins which then crystallize into a variety of shapes.

Bt-based insecticides are formulated with spores and materials produced during fermentation of Bt, but the primary active ingredients are these insecticidal protein crystals known as Cry toxins. The toxicity pathway of a native Cry toxin after ingestion of a lethal dose by a susceptible host involves 1) crystal solubilization by the appropriate midgut pH results in protoxin; 2) enzymatic cleavage of protoxin molecules at specific sites results in the activated form of the toxin; 3) binding of the activated toxin molecules to specific receptors on the brush border membrane that lead to lysis of midgut epithelial cells; 4) formation of irreparable lesions to midgut resulting in gut bacteria entering the hemocoel; and 5) death by septicemia (Knowles and Ellar 1992, Bauer and Pankratz 1992).

The gene coding for the crystal protein in Bt is called “cry” because of its crystal-producing phenotype. The first cry gene, later designated as cry1Aa, was cloned about 20 years ago by Schnepf and Whiteley (1981, Proc. Natl. Acad. Sci. USA 78, 2893-2897). Since then, numerous reports of the cloning of additional cry genes have been published.

Bt produce a variety of crystal proteins that differ in insect specificities, even within one strain. Most Bt produce crystalline insecticidal proteins active against Lepidoptera species. In addition, there are Bt isolates that produce crystalline insecticidal proteins active against Diptera and Coleoptera insect species.

As of 1997, ca. 190 Bt-based microbial insecticides were registered in the United States for control of certain lepidopteran, dipteran, and coleopteran pests (Schnepf et al. 1993). As proteins, Bt's cry genes are used to confer insect resistance in plants and microbes using genetic engineering

Among Bt crystal proteins, Cry3, Cry7, Cry8, Cry9, and Cry43 are known to be active against Coleoptera species. Of those, Cry8Ca is reported to be active against scarab beetles (Ohba et al., 1992, J. Appl. Microbiol. 14, 54-57). In 2003, Asano et al., (2003, Biological Control 28 (2003), 191-196) disclosed the finding of a new Bt strain called SDS502 that showed a very high level of activity against Anomala cuprea, A. orientalis, and Popillia japonica, which are species of scarab beetles. P. japonica, the Japanese beetle, is of particular importance in the U.S. The gene responsible for the high P. japonica activity of SDS502 has been isolated and named cry8Da. The protein encoded by this gene, Cry8Da, was found to possess a high specific activity against Japanese beetles, at least twice as high as the specific activity of Cry8Ca and Cry43Aa, two other Bt crystal proteins with insecticidal activity against Japanese beetles and other scarabs. Further information on SDS502, Cry8Da, and Cry8Da may be found in U.S. Pat. No. 6,962,977, issued Nov. 8, 2005, which is hereby incorporated by reference, in its entirety.

Among insect pests for which no known Cry pesticidal activity has been previously identified, Emerald ash borer (EAB), Agrilus planipennis Fairmaire (Coleoptera: Buprestidae), may be among the most destructive. The emerald ash borer is a wood-boring beetle indigenous to China, Japan, Korea, Mongolia, Russian Far East, and Taiwan (Yu 1992).

Adults begin to emerge from trees at the end of May, with peak emergence in June. The ash leaves are fully flushed by this time. EAB adults are relatively long-lived (2 months in the lab) and feed on the leaves of ash trees throughout their lives. Most of their days are spent up in the canopy, and require 3 weeks of maturation feeding before beginning to oviposit. There is some staggered emergence because EAB develop in one or two years, depending on the stage of the infestation due to declining ash health: early in the infestation they take 2 years when attacking branches the upper canopy weakening the tree. Once crown decline is extensive, they attack the main trunk and development is completed in one year.

In 2002, EAB was identified as the cause of extensive ash (Fraxinus spp.) mortality in southeastern Michigan and nearby Ontario, Canada. EAB has killed ca. 25 million ash trees in Lower Michigan since its arrival in North America (Cappaert et al. 2005, Poland and McCullough 2006). EAB has also spread to Michigan's Upper Peninsula, Ohio, Indiana, Maryland, Virginia, and Illinois.

Despite state and federal quarantines designed to contain EAB, the lack of effective methods to detect EAB-infested trees and the size of the infestation has resulted in a shift by regulatory agencies from a strategy of eradication to one of management. In the U.S., EAB eradication efforts involved the removal of all ash trees within a ½-mile zone around known infestations (USDA APHIS 2006). By the time the infestation was discovered and treated, however, EAB had usually already dispersed outside these eradication zones.

The bronze birch borer, A. anxius, a U.S. native relative of EAB is known to spread at a rate of 10 to 20 miles per year, and this has been proposed as an estimate for EAB's natural dispersal rate (Federal Register 2003). Recent studies of EAB flight and dispersal patterns found gravid females are obligate migrants; one mated female flew an average of 2 km per day and in 4 days flew almost 10 km (Taylor et al. 2006). Besides natural dispersal, the spread of EAB is accelerated through human-assisted movement of infested ash firewood, timber, solid-wood packing materials, and nursery stock. This resulted in the spread of EAB from Michigan to Maryland and Virginia in 2003; quarantine compliance and enforcement remains a problem. As EAB spreads throughout North America, regulatory agencies, land managers, and the public are seeking sustainable management tools such as microbial and biological controls to reduce EAB population densities and to slow its spread (Cappaert et al. 2005, GAO Report 2006, Poland and McCullough 2006, BenDor et al. 2006).

The risk EAB poses to the ash resources in North America is substantial. Of the 60 species of ash, Fraxinus spp. known worldwide, 16 species are native to North America (Haack et al. 2002). Ash species endemic to North American forests and known to be susceptible to EAB include: white ash (F. americana), green ash (F. pennsylvanica), and black ash (F. nigra) trees, which are major components of the forest; blue ash (F. quadrangulata) and pumpkin ash (F. profunda), which are less common species. There is increasing evidence that EAB will attack all Fraxinus spp., although innate susceptibility varies by species and variety (Liu et al. 2003), Wei et al. 2004, Rebek et al. 2005, Liu et al. in press).

Each Fraxinus spp. is adapted to slightly different habitats within forest ecosystems. Several species are tolerant of poorly-drained sites and wet soils, protecting environmentally-sensitive riparian areas; e.g. pure stands of black ash grow in bogs and swamps in northern areas where they provide browse, thermal cover, and protection for wildlife such as deer and moose. In agricultural and shelterbelt areas, ash provides vital shelter for livestock; e.g. ca. 25% of all trees in North Dakota are Fraxinus spp. Bark of young ash trees is a favored food of mammals including beaver, rabbit, and porcupines; older trees provide habitat for cavity-nesting birds such as wood ducks, woodpeckers, chickadees, and nuthatches; seeds are consumed by ducks, song and game birds, small mammals, and insects. Based on a recent USDA Forest Service inventory, there are ca. 8 billion ash trees on U.S. timberlands of which ca. 693 million occur in Michigan (USDA FS 2006). As of 2006, managers estimate 25 million of Michigan's ash trees have succumbed to the EAB. The ecological impact of EAB on forested areas is difficult to quantify or predict, although an average of 2.6% of our timberland trees are Fraxinus spp. (USDA FS 2006).

Ash timber is valued for applications requiring strong, hard wood, but with less rigidity than maple. In the Eastern U.S., a net volume of 114 billion board feet of ash saw timber is harvested, comprising 7.5% of the volume of all hardwood species. The impact varies by state, but in Michigan alone an estimated 7.7 billion board feet of ash timber is harvested annually. In 2001, ash accounted for over 149 million board feet of timber products produced in the U.S. White ash is the primary commercial hardwood used in production of tool handles, baseball bats, furniture, flooring, containers, railroad cars and ties, canoe paddles, snowshoes, boats, doors, and cabinets; green ash is used for both solid wood applications such as crating, boxes, handles, and for fiber in the manufacture of high grade paper; black ash is typically used for interior furniture, cabinets, and Native Americans require this species for the art of basketry.

Beyond manufacturing, ash trees play an important role in the urban landscape due to their historical resistance to pests and tolerance of adverse growing conditions, such as soil compaction and drought. Many of the ash trees that now serve as street, shade, and landscape trees were planted to replace elm trees destroyed by Dutch elm disease; ash trees now comprise 5-20% of all street trees throughout North America. In the U.S., urban areas cover ca. 3.5% of the total land area, contain more than 75% of the population, and support ca. 3.8 billion trees. The City of Chicago has ca. 603,000 ash trees that provide 14.4% of leaf area (Federal Register 2003). Trees are considered vital to the health of cities because they sequester gaseous air pollutants and particulate matter, help people conserve energy through the shade they provide, assist in the dispersal of storm water, provide shelter belts for urban fauna, and contribute aesthetic pleasure to the lives of city-dwellers and tourists. Ash is clearly a vital component of the urban forest.

The potential for economic and environmental effects if this wood boring pest were to become established in the United States is extensive. The compensatory value of the 7,553 million ash trees growing on timberlands in the U.S. is estimated $282.25 billion.

Research is underway to develop EAB management tools using conventional insecticides, however, these compounds are broadly toxic, expensive, and the most effective insecticides require handling by licensed applicators, making their use in parks, woodlots, forests, wetlands, and riparian areas economically and environmentally unacceptable (Bauer et al. 2005). The primary management tools for forest insect control are registered microbial insecticides formulated with the insect pathogenic bacterium Bacillus thuringiensis (Bt). Public acceptance of aerially-applied Bt-based microbial insecticides, used primarily in the United States for control of gypsy moth, is high because Bt is efficacious, naturally occurring, relatively host specific, biodegradable, compatible with other management strategies such as biological control, and retains an excellent safety record after decades of use throughout the world (McCullough and Bauer 2000, Siegel 2000).

Forestry is one of the few markets where microbial insecticides have replaced conventional insecticides. This resulted from development of Bt-based insecticides for management of forest insect pests such as gypsy moth and spruce budworm during the 1960s and 1970s. Technological developments in the 1980s and 1990s, including the discovery and commercialization of B. thuringiensis subsp. kurstaki HD-1 (Btk), improved formulation of high-potency products for undiluted aerial application at ultra-low volumes, and extensive operational experience, resulted in effective and environmentally acceptable insecticides for use in the management of both deciduous and coniferous forest defoliators throughout the world. Between 1990 and 1998, Btk was applied to ca. 4.5 million acres (1.8 million ha) of forested lands for management of defoliating insects.

After the discovery of EAB in 2002, NRS evaluated the activity of four registered Bt-based insecticides used for control of lepidopteran and/or coleopteran pests against EAB adults. These products proved ineffective against EAB, supporting the need for further research to identify an EAB-active Bt strain (Bauer et al. 2005). This has involved ongoing bioassay of EAB adults and larvae with some cloned toxins and ca. 30 coleopteran-active Bt strains acquired from U.S. culture and patent collections.

### SUMMARY

The present disclosure includes a microbe Bacillus thuringiensis serovar galleriae SDS502 strain having an ability of producing a toxic protein that can serve as an active ingredient of a noxious organism-controlling agent that possesses high specific insecticidal activity against the emerald ash borer (EAB), Agrilus planipennis Fairmaire (Coleoptera: Buprestidae).

The present disclosure further demonstrates that the following materials all derived from the SDS502 strain possess activity against EAB: Cry8Da purified protein in both the protoxin and toxin forms, the Cry8Da crystal toxin and spore mixture, and the fermentation material derived from a liquid fermentation of the SDS502 strain.

Another embodiment of the disclosure demonstrates increased insecticidal activity of SDS502 material against insect pests, including EAB, when mixed with a cadherin-like protein isolated from Tenebrio molitor (Coleoptera: Tenebrionidae). This peptide, rTmCad1p, was made from a portion of the Cry3Aa toxin binding cadherin (TmCad1) from Tenebrio molitor and when mixed with SDS502 materials, increases the rate of mortality of EAB.

Another embodiment of the disclosure demonstrates a droplet-imbibement bioassay that was developed to assay the various materials for activity against adult EAB.

### BRIEF DESCRIPTION OF THE DRAWING FIGURES

FIG. 1 demonstrates the droplet imbibement bioassay that was developed to assay the various materials derived from SDS502 for activity against adult EAB.

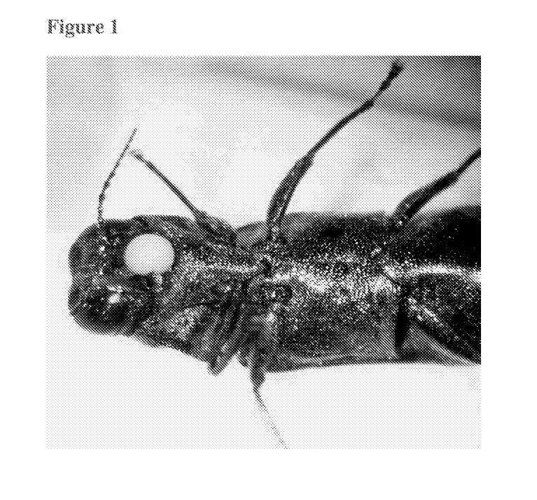

FIG. 2 depicts the molecular weight difference between the Cry8Da protoxin and the Cry8Da activated toxin when the two forms of the protein are run on an SDS-PAGE gel. The protoxin form of the protein has a molecular weight of 135 KDa, while the activated form is approximately 65 KDa.

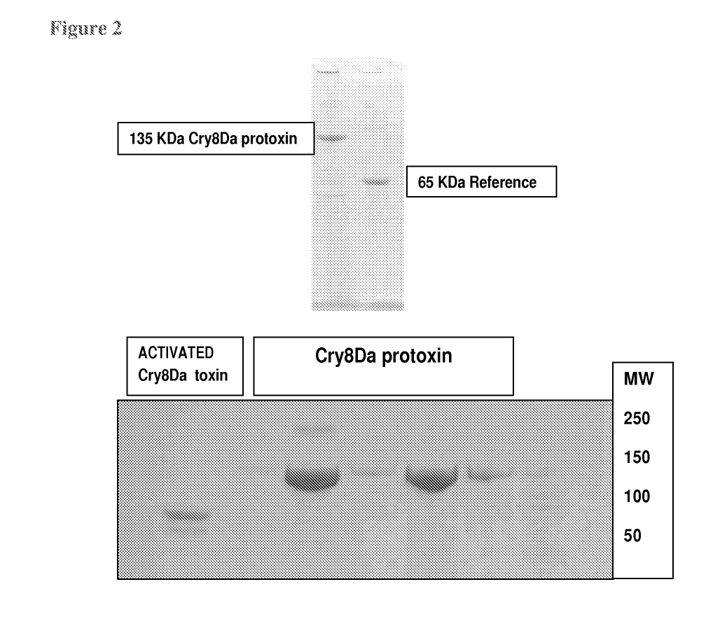

FIG. 3 depicts bioassay results of adult EAB with both the Cry8Da protoxin and Cry8Da activated toxin, solubilized in 50 mM NaPO₄ buffer at pH 8.0, demonstrated relatively high toxicities, with 96-h median lethal does (LD50's) ranging from 0.04 to 0.10 μg Cry toxin. Similar toxicities for both protoxin and activated toxin indicate EAB midgut enzymes are capable of activating this toxin. The denatured Cry8Da toxin was not toxic to EAB adults receiving doses of 2.5 ug toxin, denatured by boiling in 50 mM CAPS buffer pH 10 for 20 min, whereas all EAB adults died within 72 h of receiving similar doses of non-denatured Cry8Da toxin. This confirmed EAB adult mortality in our bioassays was caused by SDS502 Cry8Da protein, and is the first Cry toxin with confirmed toxicity against EAB. Bioassays evaluating the toxicity of Cry8Da in EAB larvae likewise confirmed insecticidal activity against the larval form of EAB.

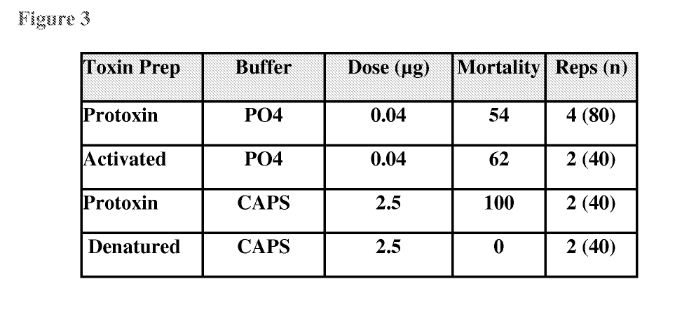

FIG. 4 depicts a mixture of SDS502 spores and crystals. The white arrows point to the crystals comprised of the Cry8Da toxin. The larger oval-shaped objects are the spores.

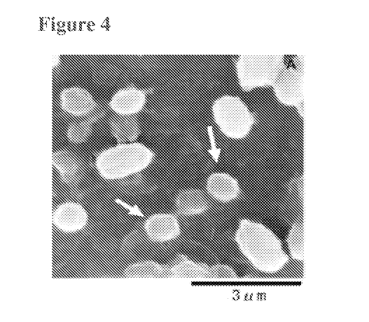

FIG. 5 depicts the % mortality of a number of spore-protein toxin crystal mixes tested against adult EAB, including 15 different strains of Bt and their relative toxicities vs. adult EAB to that of SDS502 spore-crystal mix. Bt cultures were grown in DSMG media in shaker water bath culture, crystal/spore spun down at 27,000 g and washed at 20,000 g with sterile DiH2O and NaCl, resuspended in sterile DiH2O and sonicated, dilutions loaded on SDS PAGE, and protein concentrations determined using densitometer using Gel Doc correlated with the BSA as standard curve.

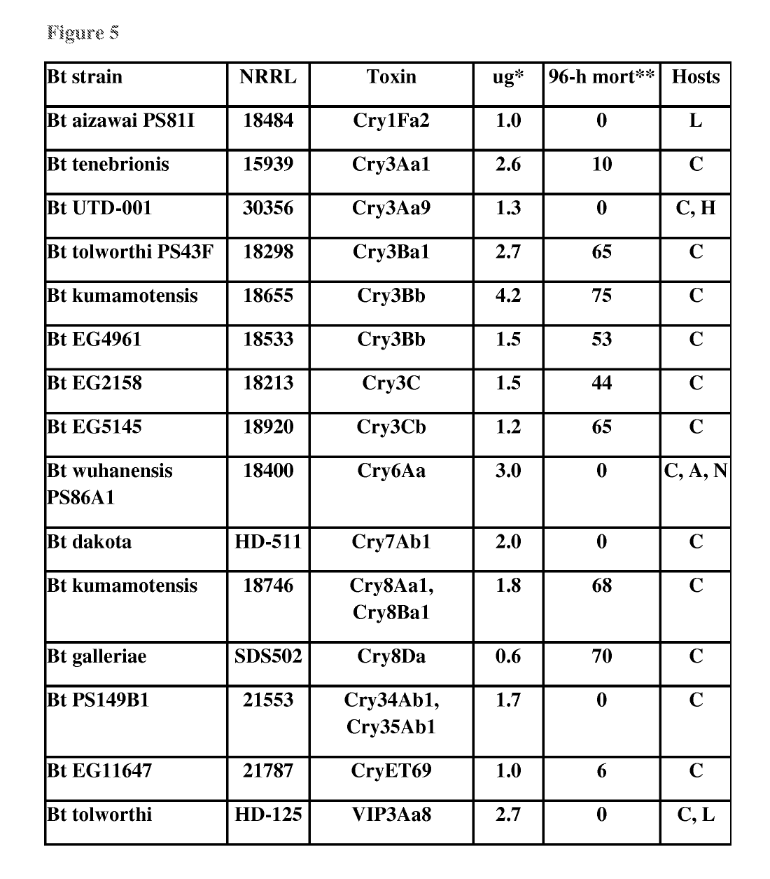

FIG. 6 depicts the median lethal dose (LD50) of the SDS502 native spore-crystal mix against adult EAB. Even-aged cohorts of female & male EAB adults were dosed individually with 0.5 uL droplets of SDS502 crystal/spore complex, which was a freeze-dried powder with known concentration of Cry8Da toxin. The powder was suspended in DiH₂0and the stock suspension was serially diluted to prepare doses of 0.03125, 0.0625, 0.125, 0.25, and 0.5 μg Cry toxin, with DiH₂0used as the control. Fifteen EAB were dosed individually for each of the 6 treatments/bioassay, with two replicate bioassays, and analyzed with SAS Proc Probit.

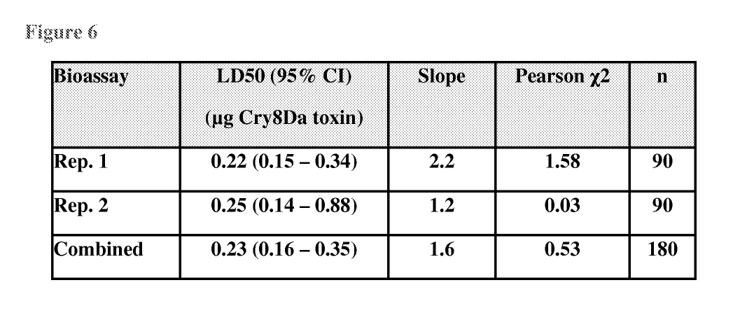

FIG. 7 depicts adult EAB cumulative mortality % in days after dosing with various concentrations of the SDS502 native spore-crystal mix.

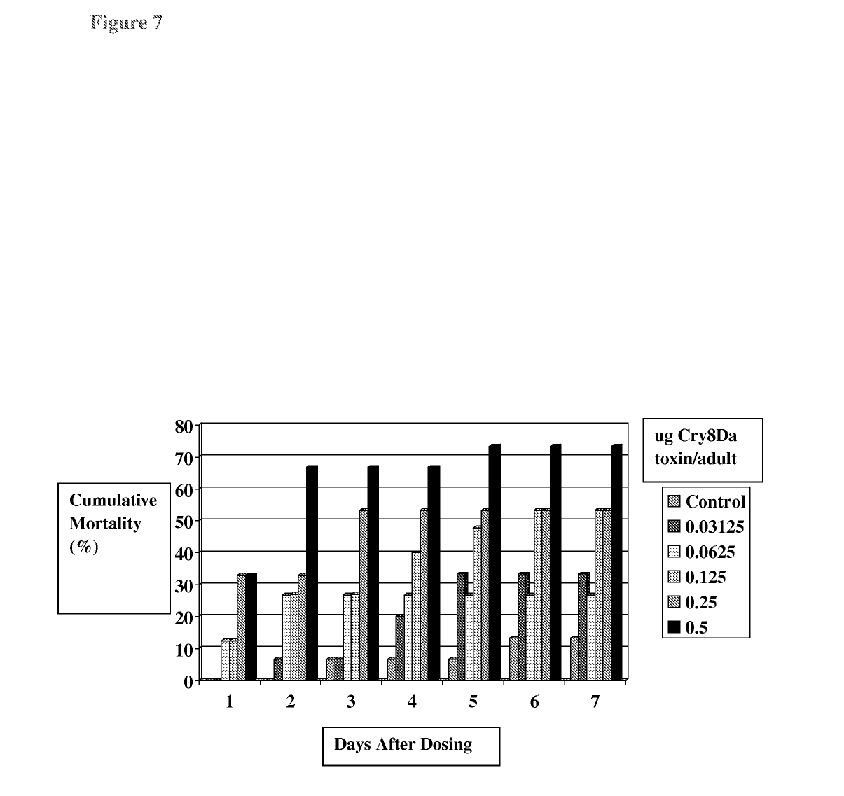

FIG. 8 depicts adult EAB mortality % in leaf dip assays in which Ash leaves were dipped in SDS502 technical powder that was suspended in Silwet.

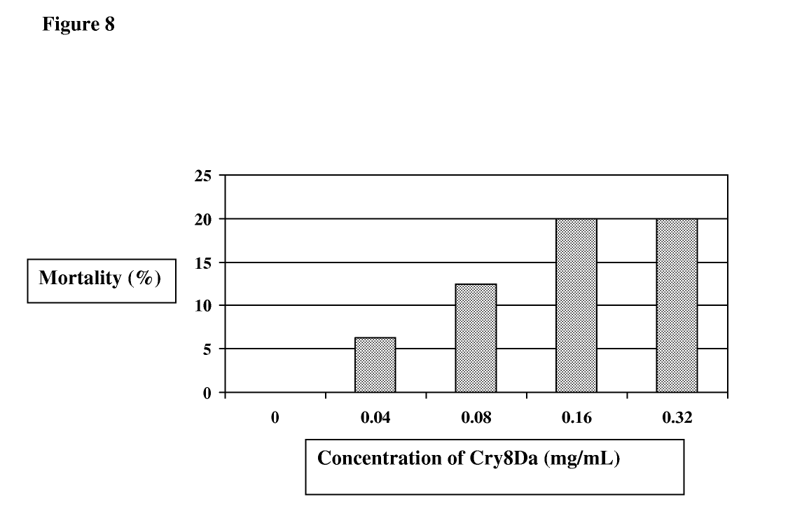

FIG. 9 depicts bioassay results of the relative toxicities against adult EAB with purified Cry8Da toxin when mixed or not mixed with a cadherin-like protein, the peptide rTmCad1p, made from a portion of the cadherin, TmCad1, isolated from Tenebrio molitor (Coleoptera: Tenebrionidae).

FIG. 10 depicts a peptide, rTmCad1p, made from a portion of the Cry3Aa toxin binding cadherin from T. molitor (TmCad1) that included the predicted toxin binding region. The TmCad1 peptide fragment corresponded to amino acid residues 1,322-1,516 of the full length protein (translation of nucleotides 4,076-4,661). Bold letters and underline designate TmCad1 amino acids (195 residues), whereas 37 residues at amino terminus are from pET151-D-TOPO vector, including polyhistidine tag, V5 epitope tag, and TEV protease cleavage site. This peptide was expressed in vitro in E. coli and was purified for bioassays.

FIG. 11 depicts a bioassay set-up for EAB adults exposed to Bt SDS502 formulation on ash foliage. The arrow shows a dried droplet of the SDS502 formulation.

FIG. 12 is a graph depicting cumulative % mortality of EAB adults during exposure to ash foliage with droplets of SDS502 formulation.

### BRIEF DESCRIPTION OF THE SEQUENCE LISTING

SEQ ID NO: 1 shows a Cry8Da protein derived from the SDS502 strain.

SEQ ID NO: 2 shows a rTmCad1p peptide made to a portion of the Cry3Aa toxin binding cadherin from T. molitor (TmCad1).

SEQ ID NO: 3 shows a portion of the rTmCad1p peptide that corresponds to TmCad1 amino acid residues 1,322-1,516 of the full length TmCad1 protein of T. molitor.

### DETAILED DESCRIPTION

A. Overview

Screening of the Cry8Da protein has demonstrated activity against the emerald ash borer (EAB), Agrilus planipennis Fairmaire (Coleoptera: Buprestidae).

This high specific activity against EAB was demonstrated in laboratory bioassays of EAB adult and larvae with both the Cry8Da protoxin and Cry8Da activated toxin and also with materials comprised of a mix of the Cry8Da crystals and spore. This confirmed EAB mortality in our bioassays was caused by SDS502 Cry8Da protein.

The present disclosure provides a microbe Bacillus thuringiensis serovar galleriae SDS502 strain from which the biological components derived from, as well as the SDS502 strain itself, possess insecticidal activity against the emerald ash borer (EAB), Agrilus planipennis Fairmaire (Coleoptera: Buprestidae).

The SDS502 strain has the ability to produce a protein that is toxic to EAB larvae and adults and can serve as an active ingredient of an EAB controlling agent in the form of a fermentation of the SDS502 strain that is formulated via a number of various chemistries, whether as a liquid or wettable powder formulation for ground or aerial spraying or as a granule for ground applications.

The biological components possessing this toxic activity are: the Cry8Da protein having a pesticidal activity produced by the strain, or any of the following: a protein having an amino acid sequence obtainable from the amino acid sequence of the Cry8Da protein by addition, deletion or substitution of a plurality of amino acids and having similar pesticidal activity, a DNA encoding the Cry8Da protein having pesticidal activity including a synthesized DNA or gene, and a microbe transformed with the DNA, a protein with an amino acid sequence having 95%, 90%, 85%, 80%, or 75% sequence identity to the sequence of SEQ ID NO: 1 and having pesticidal activity.

In addition, the present disclosure describes an additive that when mixed with the SDS502 strain and its pesticidal protein, the noxious organism-controlling characteristics of the SDS502 strain against EAB is increased. This additive is a cadherin-like protein isolated from Tenebrio molitor (Coleoptera: Tenebrionidae). In an additional embodiment, the additive may be a protein or peptide having 95%, 90%, 85%, 80%, or 75% sequence identity to the peptide of SEQ ID NO: 2 or of SEQ ID NO: 3.

B. General Techniques

Practice of the methods of the present disclosure will generally utilize, unless otherwise indicated, conventional techniques of molecular biology, microbiology, cell biology, biochemistry, and immunology, which are within the skill of the art. Such techniques are fully explained in the literature, for example, in Cell Biology: A Laboratory Notebook (J. E. Cellis, ed., 1998); Current Protocols in Molecular Biology (F. M. Ausubel et al., eds, 1987); Short Protocols in Molecular Biology (Wiley and Sons, 1999). Furthermore, procedures employing commercially available assay kits and reagents will typically be used according to manufacturer defined protocols unless otherwise noted.

C. Definitions

The term “technical powder” is used herein to describe the material resulting from a liquid fermentation of a starting culture of the SDS502 strain after which the liquid fermentation is processed (i.e. spray dried or lyophilized) to produce the dried technical powder. This powder is comprised of the SDS502 organism, its crystal toxin and spores.

The terms “EAB controlling agent” or “noxious organism-controlling agent” are used to describe a formulation of a SDS502-based technical powder that can be applied via a number of various application methods in a number of different environments with the purpose of controlling EAB. For example, the agent can be a liquid or wettable powder formulation for ground or aerial spraying or can be a granule for ground applications.

The term “gene” is used broadly to refer to any segment of DNA associated with a biological function. Genes include coding sequences and/or the regulatory sequences required for their expression as well as sequences that allow combinatorial functions as in the case of the methods of the present disclosure where two genes are fused via a linker sequence to produce a single new gene with more complex biological functions. Genes also include non-expressed DNA segments that have a variety of functions needed for the expression of that gene such as recognition sequences for other proteins. Genes can be obtained from a variety of sources, including cloning from a source of interest such as any living organism, or synthesizing from known or predicted sequence information, and may include artificial sequences designed to have desired characteristics.

The terms “identical” or percent “identity,” in the context of two or more nucleic acids or polypeptide sequences, refer to two or more sequences or subsequences that are the same. Two sequences are “substantially identical” if two sequences have a specified percentage of amino acid residues or nucleotides that are the same (i.e., 60% identity, optionally 65%, 70%, 75%, 80%, 85%, 90%, 95%, or 99% identity over a specified region, or, when not specified, over the entire sequence), when compared and aligned for maximum correspondence over a comparison window, or designated region as measured using one of the following sequence comparison algorithms or by manual alignment and visual inspection. Optionally, the identity exists over a region that is at least about 50 nucleotides (or 10 amino acids) in length, or more preferably over a region that is 100 to 500 or 1000 or more nucleotides (or 20, 50, 200 or more amino acids) in length.

For sequence comparison, typically one sequence acts as a reference sequence, to which test sequences are compared. When using a sequence comparison algorithm, test and reference sequences are entered into a computer, subsequence coordinates are designated, if necessary, and sequence algorithm program parameters are designated. Default program parameters can be used, or alternative parameters can be designated. The sequence comparison algorithm then calculates the percent sequence identities for the test sequences relative to the reference sequence, based on the program parameters.

A “comparison window”, as used herein, includes reference to a segment of any one of the number of contiguous positions including, but not limited to from 20 to 600, usually about 50 to about 200, more usually about 100 to about 150 in which a sequence may be compared to a reference sequence of the same number of contiguous positions after the two sequences are optimally aligned. Methods of alignment of sequences for comparison are well known in the art. Optimal alignment of sequences for comparison can be conducted, e.g., by the local homology algorithm of Smith and Waterman (1970) Adv. Appl. Math. 2:482c, by the homology alignment algorithm of Needleman and Wunsch, J. Mol. Biol. 48:443, 1970, by the search for similarity method of Pearson and Lipman, Proc. Nat'l. Acad. Sci. USA 85:2444, 1988, by computerized implementations of these algorithms (GAP, BESTFIT, FASTA, and TFASTA in the Wisconsin Genetics Software Package, Genetics Computer Group, 575 Science Dr., Madison, Wis.), or by manual alignment and visual inspection (see, e.g., Brent et al., Current Protocols in Molecular Biology, John Wiley & Sons, Inc. (ringbou ed., 2003)).

Two examples of algorithms that are suitable for determining percent sequence identity and sequence similarity are the BLAST and BLAST 2.0 algorithms, which are described in Altschul et al., Nuc. Acids Res. 25:3389-3402, 1977; and Altschul et al., J. Mol. Biol. 215:403-410, 1990, respectively. Software for performing BLAST analyses is publicly available through the National Center for Biotechnology Information. This algorithm involves first identifying high scoring sequence pairs (HSPs) by identifying short words of length W in the query sequence, which either match or satisfy some positive-valued threshold score T when aligned with a word of the same length in a database sequence. T is referred to as the neighborhood word score threshold (Altschul et al., supra). These initial neighborhood word hits act as seeds for initiating searches to find longer HSPs containing them. The word hits are extended in both directions along each sequence for as far as the cumulative alignment score can be increased. Cumulative scores are calculated using, for nucleotide sequences, the parameters M (reward score for a pair of matching residues; always>0) and N (penalty score for mismatching residues; always<0). For amino acid sequences, a scoring matrix is used to calculate the cumulative score. Extension of the word hits in each direction are halted when: the cumulative alignment score falls off by the quantity X from its maximum achieved value; the cumulative score goes to zero or below, due to the accumulation of one or more negative-scoring residue alignments; or the end of either sequence is reached. The BLAST algorithm parameters W, T, and X determine the sensitivity and speed of the alignment. The BLASTN program (for nucleotide sequences) uses as defaults a wordlength (W) of 11, an expectation (E) or 10, M=5, N=−4 and a comparison of both strands. For amino acid sequences, the BLASTP program uses as defaults a wordlength of 3, and expectation (E) of 10, and the BLOSUM62 scoring matrix (see Henikoff and Henikoff, Proc. Natl. Acad. Sci. USA 89:10915, 1989) alignments (B) of 50, expectation (E) of 10, M=5, N=−4, and a comparison of both strands.

The BLAST algorithm also performs a statistical analysis of the similarity between two sequences (see, e.g., Karlin and Altschul, Proc. Natl. Acad. Sci. USA 90:5873-5787, 1993). One measure of similarity provided by the BLAST algorithm is the smallest sum probability (P(N)), which provides an indication of the probability by which a match between two nucleotide or amino acid sequences would occur by chance. For example, a nucleic acid is considered similar to a reference sequence if the smallest sum probability in a comparison of the test nucleic acid to the reference nucleic acid is less than about 0.2, more preferably less than about 0.01, and most preferably less than about 0.001.

D. Methods and Uses

The present disclosure relates to a protein having an EAB pesticidal activity, DNA encoding the protein, an EAB-controlling agent and -controlling method as well as to the microbe Bacillus thuringiensis serovar galleriae SDS502 strain having an ability of producing the toxic protein that can serve as an active ingredient of an EAB-controlling agent.

Using several different toxic protein materials derived from SDS502, this disclosure has demonstrated that the SDS502 Cry8Da protein possesses pesticidal activity against adult and larvae of EAB.

In yet another aspect, the present disclosure provides a method for increasing the pesticidal activity, including specific toxic activity and rate of activity against EAB larvae and adults, of SDS502 by the addition of a peptide, rTmCad1p.

The following examples are provided to show that the methods of the present disclosure may be used to generate a SDS502-based control agent that can be used to control the emerald ash borer (EAB), Agrilus planipennis Fairmaire (Coleoptera: Buprestidae). And that a cadherin-like protein can be added to the SDS502-based control agent to increase the effectiveness of the agent to control insects targeted by the agent.

Those skilled in the art will recognize that while specific embodiments have been illustrated and described, they are not intended to limit the invention disclosed herein.

### EXAMPLES

### Example 1

### The Cry8Da Protein is Toxic to EAB Adults and Larvae

Bioassay results of adult EAB with both the Cry8Da protoxin and Cry8Da activated toxin, solubilized in 50 mM NaPO₄ buffer at pH 8.0, demonstrated relatively high toxicities, with 96-h LD₅₀s ranging from 0.04 to 0.10 μg Cry toxin. Similar toxicities for both protoxin and activated toxin indicate EAB midgut enzymes are capable of activating this toxin. The denatured Cry8Da toxin was not toxic to EAB adults receiving doses of 2.5 ug toxin, denatured by boiling in 50 mM CAPS buffer pH 10 for 20 min, whereas all EAB adults died within 72 h of receiving similar doses of non-denatured Cry8Da toxin. This confirmed EAB adult mortality in our bioassays was caused by SDS502 Cry8Da protein, and is the first Cry toxin with confirmed toxicity against EAB. Bioassays evaluating the toxicity of Cry8Da in EAB larvae likewise confirmed insecticidal activity against the larval form of EAB.

### Example 2

### The Cry8Da Protein Crystal-Spore Mix is Toxic to EAB Adults and Larvae

In addition to the purified forms of the Cry8Da protein, the native form of this protein was also tested against EAB adults and larvae.

Bt cultures were grown in DSMG media in shaker water bath culture, crystal/spore spun down at 27,000 g and washed at 20,000 g with sterile DW and NaCl, resuspended in sterile DW and sonicated, dilutions loaded on SDS PAGE, and protein concentrations determined using densitometer using Gel Doc correlated with the BSA as standard curve.

In brief: even-aged cohorts of female & male EAB adults were dosed individually with 0.5 uL droplets of Btg SDS-502 crystal/spore complex, which was a freeze-dried powder with known concentration of Cry8Da toxin. The powder was suspended in DW and serial dilution of the stock suspension was diluted to prepare doses of 0.03125, 0.0625, 0.125, 0.25, 0.5 ug Cry toxin, with DW used as the control. We dosed 15 EAB individually for each of the 6 treatments/bioassay, with two replicate bioassays, and analyzed with SAS Proc Probit.

### Example 3

### The SDS502 Technical Powder is Toxic to EAB Adults and Larvae

EAB mortality was demonstrated in leaf dip assays in which Ash leaves were dipped in SDS502 technical powder that was suspended in Silwet.

The SDS502 strain was cultured in a medium in which general bacteria can grow by a common fermentation technique. The following medium was used in a 5 liter fermentation of SDS502 to produce the technical powder:

### Glucose Fed-Batch Type Fermentation

4% (40 g/L) Defatted Soy flour
1 g/L NH₄Cl
1.5 g/L KH₂PO₄
3.5 g/L K₂HPO₄
0.5g/L MgSO₄ 7H₂O
10 mg/L FeSO₄ 7H₂O
10 mg/L MnSO₄ H₂O
pH adjust to 7.0 with KOH or H₂SO₄

Run fed batch with glucose feeding (feeding rate: 0.0125% of medium volume/hr (0.125 g/L/hr)) from 3 hr to 16 hr. Following the fermentation, the solid material was then centrifuged and spray-dried. The material was then tested.

In contrast to using the SDS502 strain and/or SDS502 strain-produced crystal protein as a single active ingredient, it is also possible to mix it with herbicides, various pesticides, bactericides or plant growth regulators which are effective to other noxious organisms, synergists for multiplying the effect, attractants as well as plant nutritive agents, fertilizers and so forth that are intended to obtain other functions.

### Example 4

### Addition of a Cadherin-Like Protein to Cry8Da Protein Increases the Toxicity to EAB Adults and Larvae

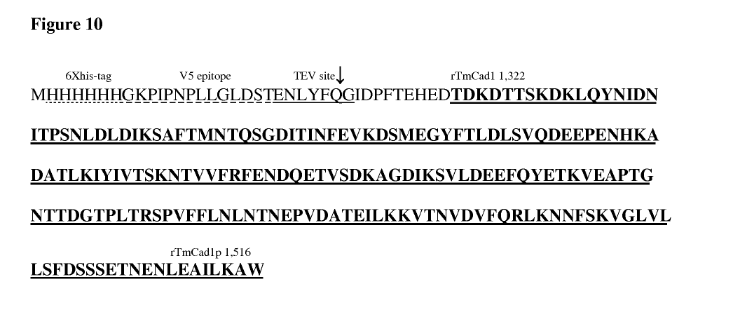

A method for increasing the pesticidal activity, including specific toxic activity against EAB larvae and adults, of SDS502 by the addition of a protein, a cadherin-like protein was demonstrated. A peptide, rTmCad1p, was made using a portion of the Cry3Aa toxin binding cadherin (TmCad1) from Tenebrio molitor (Coleoptera: Tenebrionidae) that included the predicted toxin binding region. The TmCad1 peptide fragment corresponded to amino acid residues 1,322-1,516 of the full length protein (translation of nucleotides 4,076-4,661. This peptide was expressed in vitro in E. coli and was purified for bioassays. FIG. 10 depicts the sequence of the rTmCad1p peptide.

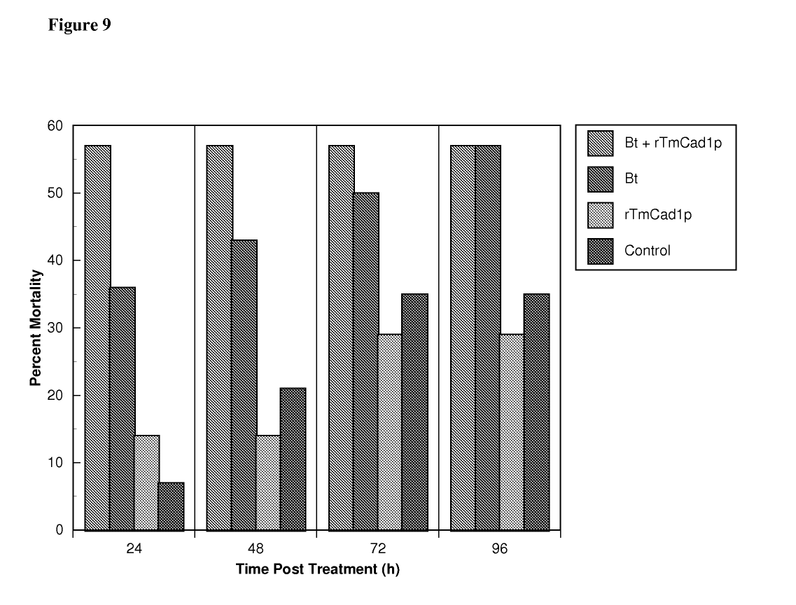

Using the droplet-imbibement method, an even-aged cohort of EAB adults were dosed with purified Cry8Da toxin solubilized in phosphate buffer with the following treatments: 1) Cry8Da toxin, 2) Cry8Da toxin and rTmCad1, 3) rTmCad1,or 4) buffer control. At a constant Cry8Da dose, rTmCad1 increased the toxicity of CryDa toxin in EAB adults. These results (FIG. 9) support the possible use of this peptide to improve the toxicity of Cry8Da from SDS502 for use in management of EAB.

### Example 5

### The Formulated SDS502 Technical Powder is Toxic to EAB Adults and Inhibits Feeding by EAB Adults of Ash Leaves which have been Treated with a SDS502 Formulation (Composition)

Bt bioinsecticides are made typically with spray- or freeze-dried sporulated Bt cultures (known as Bt technical powder or as Technical Grade Active Ingredient (“TGAI”), and formulated with spray adjuvants (spreaders, stickers, UV protectants) and feeding stimulants. An application of a formulated Bt spray is deposited as very small droplets on leaf surfaces, and the size and number of spray droplets is known to affect the toxicity of Bt sprays, which must be eaten to cause mortality. To evaluate, SDS502 technical powder must be formulated. Cry toxins must be consumed due to toxic action in the insect midgut, however, feeding cessation occurs rapidly following ingestion, thus feeding stimulants are typically added to the formulation.

Droplet Assays on Ash Leaves: We produced a Bt SDS502 formulation for testing consisting of SDS502 native crystals and spores which were suspended in 10% sucrose solution. The sucrose is used to improve adhesion of the Bt powder to the leaves (a “sticker”) and to overcome Bt feeding inhibition (“feeding stimulant”).

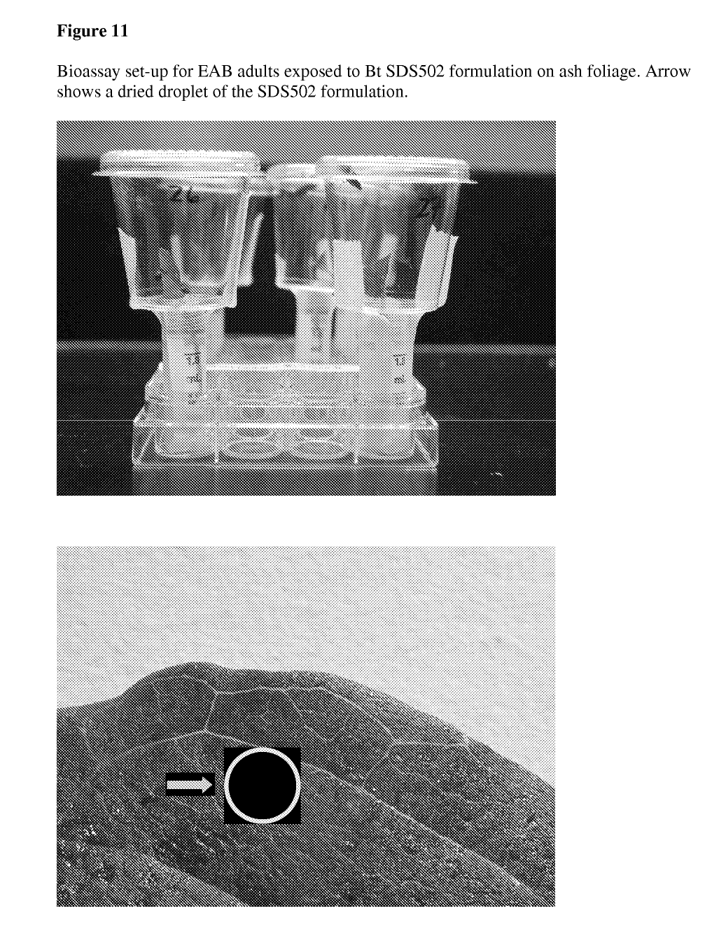

To evaluate the efficacy of the SDS502 formulation, 0.02 uL droplets of the material were applied in the following manner: Ten droplets applied to 1-cm2 pieces of ash leaf in different patterns (along leaf margin, along midrib, scattered). Each droplet contained ca. 0.3 ug Cry8Da toxin, and the average diameter of 30 measured droplets was 819 μm (FIG. 11). EAB adults were exposed individually to a treated or control (sucrose only without TGAI) leaf for 96-h and monitored for daily mortality. If consumed, the leaf was replaced with an untreated leaf.

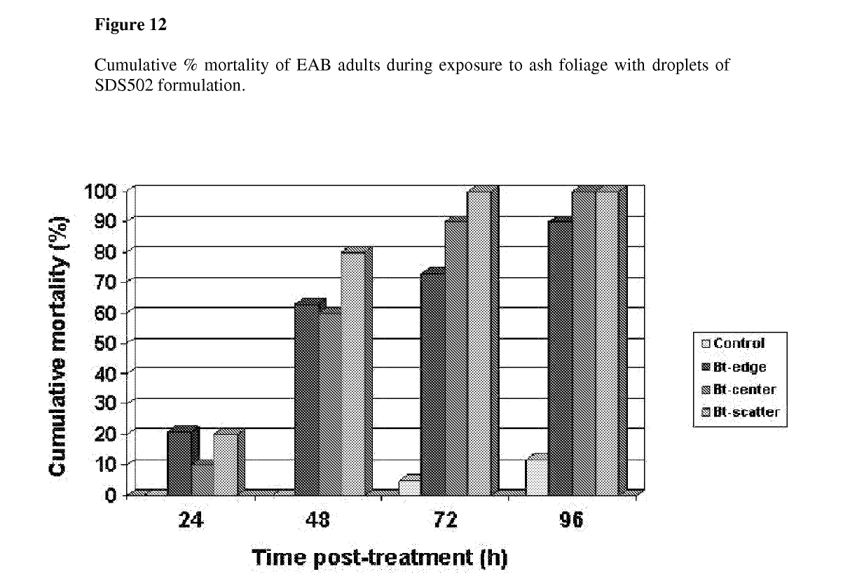

Control EAB adults consumed ca. 90 to >100% of 1-cm² leaf, whereas the Bt-treated EAB adults consumed ca. <5 to 60% of the leaf. After 24 h, ca. 15% of EAB were dead and after 48 h, 60 to 80%; by 96 h, >90% of adults feeding on the Bt-treated leaves died vs. 12% of controls (FIG. 12). The mortality response of EAB adults was similar when exposed to droplets on leaf margins, along the center of the leaf, or scattered across the leaf. An average 2.2 droplets were visibly consumed per leaf ranging from 0 to 10, which suggests the beetles consumed an average of 0.66 ug, which is almost three times the LD50 of this Bt SDS502 in EAB.

We claim:

1. A method of controlling Agrilus planipennis Fairmaire, the method comprising:
treating a plant with a composition having pesticidal activity to Agrilus planipennis Fairmaire;
wherein the composition comprises a Bacillus thuringiensis protein.

2. The method of claim 1, wherein the Bacillus thuringiensis protein comprises an amino acid sequence having at least 85% sequence identity to SEQ ID NO: 1

3. The method of claim 2, wherein the Bacillus thuringiensis protein comprises an amino acid sequence having at least 95% sequence identity to SEQ ID NO: 1.

4. The method of claim 3, wherein the Bacillus thuringiensis protein comprises an amino acid sequence of SEQ ID NO: 1.

5. The method of claim 1, wherein the composition further comprises a Tenebrio molitor peptide.

6. The method of claim 5, wherein the Tenebrio molitor peptide comprises an amino acid sequence of having at least 85% sequence identity to SEQ ID NO: 3

7. The method of claim 6, wherein the Tenebrio molitor peptide comprises an amino acid sequence of having at least 95% sequence identity to SEQ ID NO: 3.

8. The method of claim 7, wherein the Tenebrio molitor peptide comprises an amino acid sequence of SEQ ID NO: 3.

9. The method of claim 2, wherein the plant is of the genus Fraxinus.

10. The method of claim 9, wherein the plant of the genus Fraxinus is selected from the group consisting of F. Americana, F. pennsylvanica, F. nigra, and F. profunda.

11. The method of claim 2, wherein the plant is infested with Agrilus planipennis Fairmaire.

12. The method of claim 1, wherein the composition is selected from the group consisting of a liquid composition, a powdered composition, and a granular composition.

13. The method of claim 1, wherein the composition has pesticidal activity to larval Agrilus planipennis Fairmaire.

14. The method of claim 1, wherein the composition has pesticidal activity to adult Agrilus planipennis Fairmaire.

15. A method for controlling Agrilus planipennis Fairmaire, the method comprising:
administering a composition having pesticidal activity to Agrilus planipennis Fairmaire to a Agrilus planipennis Fairmaire;
wherein the composition comprises a Bacillus thuringiensis protein.

16. The method of claim 15, wherein the composition is administered orally.

17. The method of claim 15, wherein the composition further comprises a Tenebrio molitor peptide.

18. The method of claim 17, wherein the Bacillus thuringiensis protein comprises an amino acid sequence of SEQ ID NO: 1, and the Tenebrio molitor peptide comprises an amino acid sequence of SEQ ID NO: 3.

19. A composition for controlling a noxious organism comprising:
a Bacillus thuringiensis protein; and
a Tenebrio molitor peptide.

20. The composition of claim 19, wherein the Bacillus thuringiensis protein comprises an amino acid sequence having at least 85% sequence identity to SEQ ID NO: 1.

21. The composition of claim 20, wherein the Bacillus thuringiensis protein comprises an amino acid sequence having at least 95% sequence identity to SEQ ID NO: 1.

22. The composition of claim 21, wherein the Bacillus thuringiensis protein comprises an amino acid sequence of SEQ ID NO: 1.

23. The composition of claim 19, wherein the Tenebrio molitor peptide comprises an amino acid sequence having at least 85% sequence identity to SEQ ID NO: 3.

24. The composition of claim 23, wherein the Tenebrio molitor peptide comprises an amino acid sequence having at least 95% sequence identity to SEQ ID NO: 3.

25. The composition of claim 24, wherein the Tenebrio molitor peptide comprises an amino acid sequence of SEQ ID NO: 3.

26. The composition of claim 19, wherein the composition has pesticidal activity to Agrilus planipennis Fairmaire.

27. The composition of claim 26, wherein the composition has pesticidal activity to larval Agrilus planipennis Fairmaire.

28. The composition of claim 26, wherein the composition has pesticidal activity to adult Agrilus planipennis Fairmaire.

29. The composition of claim 19, wherein the composition is selected from the group consisting of a liquid composition, a powdered composition, and a granular composition.


SEQUENCE LISTING (3 sequences)

SEQ ID NO: 1 - protein, 1167 aa, Bacillus thuringiensis
MSPNNQNEYEILDASSSTSVSDNSVRYPLANDQTTTLQNMNYKDYLRMSEGENPELFGNPETFISSSTVQTGIGIVGQVLGALGVPFAGQIASFYSFIVGQLWPSSTVSVWEMIMKQVEDLIDQKITDSVRKTALAGLQGLGDGLDVYQKSLKNWLENRNDTRARSVVVTQYIALELDFVAKIPSFAISGQEVPLLSVYAQAANLHLLLLRDASIFGAEWGFTPGEISTFYDRQVTRTAQYSDYCVKWYNTGLDKLKGTNAASWLKYHQFRREMTLLVLDLVALFPNYDTRTYPIETTAQLTREVYTDPIVFNRETSGGFCRRWSLNSDISFSEVESAVIRSPHLFDILSEIEFYTTRAGLPLNNTEYLEYWVGHSIKYKNTNASSALERNYGTITSNKIKYYDLANKDIFQVRSLGADLANYYAQVYGVPYASFTLLDKNTGSGSVGGFTYSKPHTTMQVCTQNYNTIDEIPPENEPLSRGYSHRLSHITSYSFSKNASSPARYGNLPVFAWTHRSADVTNTVYSDKITQIPVVKAHTLVSGTTVIKGPGFTGGNILKRTSSGPLAYTSVSVKSPLSQRYRARIRYASTTNLRLFVTISGTRIYSINVNKTMNKGDDLTFNTFDLATIGTAFTFSNYSDSLTVGADSFASGGEVYVDKFELIPVNATFEAEEDLDVAKKAVNGLFTSKKDALQTSVTDYQVNQAANLVECLSDELYPNEKRMLWDAVKEAKRLVQARNLLQDTGFNRINGENGWTGSTGIEVAEGDVLFKDRSLRLTSAREIDTETYPTYLYQQIDESLLKPYTRYKLKGFIGSSQDLEIKLIRHRANQIVKNVPDNLLPDVLPVNSCGGIDRCSEQQYVDANLALENNGENGNMSSDSHAFSFHIDTGEIDLNENTGIWVVFKIPTTNGYATLGNLELVEEGPLSGETLERAQQQEQQWQDKMARKRGASEKAYYAAKQAIDRLFADYQDQKLNSGVEMSDMLAAQNLVQSIPYVYNDALPEIPGMNYTSFTELTNRLQQAWNLYDLRNAIPNGDFRNGLSDWNATSDVNVQQLSDTSVLVIPNWNSQVSQQFTVQPNYRYVLRVTARKEGVGDGYVIIRDGANQTETLTFNICDDDTGVLSADQTSYITKTVEFTPSTEQVWIDMSETEGVFNIESVELVLEEE

SEQ ID NO: 2 - protein, 232 aa, Tenebrio molitor
MHHHHHHGKPIPNPLLGLDSTENLYFQGIDPFTEHEDTDKDTTSKDKLQYNIDNITPSNLDLDIKSAFTMNTQSGDITINFEVKDSMEGYFTLDLSVQDEEPENHKADATLKIYIVTSKNTVVFRFENDQETVSDKAGDIKSVLDEEFQYETKVEAPTGNTTDGTPLTRSPVFFLNLNTNEPVDATEILKKVTNVDVFQRLKNNFSKVGLVLLSFDSSSETNENLEAILKAW

SEQ ID NO: 3 - protein, 195 aa, Tenebrio molitor
TDKDTTSKDKLQYNIDNITPSNLDLDIKSAFTMNTQSGDITINFEVKDSMEGYFTLDLSVQDEEPENHKADATLKIYIVTSKNTVVFRFENDQETVSDKAGDIKSVLDEEFQYETKVEAPTGNTTDGTPLTRSPVFFLNLNTNEPVDATEILKKVTNVDVFQRLKNNFSKVGLVLLSFDSSSETNENLEAILKAW